(19) United States
(12) Patent Application Publication
(10) Pub. No.: US 2003/0157466 A1
(43) Pub. Date: Aug. 21, 2003

(54) Flexible ski-map

(76) Inventor: Robert B. Campbell, Boise, ID (US)

Correspondence Address: PEDERSEN & COMPANY, PLLC, P.O. BOX 2666, BOISE, ID, 83701, US

(21) Appl. No.: 10/340,107

(22) Filed: Jan. 9, 2003

Related U.S. Application Data
(60) Provisional application No. 60/347,316, filed on Jan. 9, 2002.

(51) Int. Cl. G09B 29/00

(52) U.S. Cl. 434/150; 40/329

(57) ABSTRACT

A 3-dimensional map for ski areas or other such regions is provided. The map is preferably constructed of flexible latex rubber or other suitable material with “memory” that may be repeatedly unfolded or unrolled and expanded to display the contours of the area and folded up again for convenient storage and/or transport when not in use. The surface of the map is painted, printed or otherwise formed to show pertinent information to visitors of an area. The flexible map may also be embodied in hat or cap designs as a novelty.

### DESCRIPTION

This application claims priority from U.S. Provisional Patent Application Serial No. 60/347,316, filed on Jan. 9, 2002, entitled “Flexible Ski-Map”, the disclosure of which is herein incorporated by reference.

### BACKGROUND OF THE INVENTION

1. Field of the Invention

This invention relates, in general, to geographical navigation tools. More specifically, this invention relates to maps offering 3-dimensional representations of areas such as ski resorts that may be easily folded or rolled for convenient storage and transport.

2. Related Art

The navigation of unfamiliar areas often requires the use of a map. Many previous works have addressed the need for such an instrument. Currently, maps can be purchased which offer representations of topography, transportation routes, points of interest, and many other features. The type of map chosen is often dependent upon the activity being pursued.

Most ski areas currently produce 2-dimensional maps of the available skiing area and surrounding region for visitors. These maps typically display a number of the area's features such as accessible ski runs and their degree of difficulty as well as other pertinent information. These maps are designed to fold such that they may be carried and/or stored in the pocket of a ski coat or other suitable compartment for a day, or as long as is required.

Still, there is a need for a 3-dimensional geographical navigational tool which adds detail and realism to representations of regions such as ski resorts. Preferably, such a tool is portable, easily foldable or rollable, and durable.

### SUMMARY OF THE INVENTION

The instant invention is a 3-dimensional map of an area, for example, a ski, mountain biking, or hiking area, which may be easily folded, rolled, or compressed, and conveniently carried by the user in any appropriate compartment, such as a pocket. The map may be constructed of latex rubber or any flexible material.

In use, the map will preferably expand or unroll to a 3-dimensional form that shows the approximate geography and contour of the area being portrayed. Preferably, when unfolded or unrolled, the map returns to its intended 3-dimensional shape and does not retain any significant curvature, creases, or fold marks caused by the compression, rolling, or folding. This way, when the user places the map on a surface for viewing or display, there is preferably no curvature or “warp” in the bottom perimeter/surface upon which the map sits, and the map may represent the geography without fold lines or other creases in the map surface. When not in use, the invention may be folded, rolled, or compressed and stored until its next use.

The surface of the map may be painted or printed with an image to reveal any helpful or desired information. The information displayed to the user may include: ski runs and the degree of difficulty, base lodges, ski lifts and/or any other information deemed pertinent to successful navigation and/or enjoyment of an area by visitors. The information for a mountain bike or hiking area may include: trails and degree of difficulty, properly lines, water or rest facilities, wildlife habitats, historical sites, and/or any other information deemed pertinent to successful navigation and/or enjoyment of the area.

### BRIEF DESCRIPTION OF THE DRAWINGS

FIG. 1 is a top view of one embodiment of the flexible ski map of the present invention in its opened-up state.

FIG. 2 is a side-cross-sectional view along arrows 2-2 in FIG. 1.

FIG. 3 is a side view of an embodiment of the present invention in its rolled-up state.

FIG. 4 is a side view of another embodiment of the invention in a sun hat design.

FIG. 5 is a side view of yet another embodiment of the invention in a baseball cap design.

FIG. 6 is a side view of the embodiment of FIG. 5, with added ski run markings, chair lift markings, and an “expert run” black diamond symbol on one ski run.

### DETAILED DESCRIPTION OF THE INVENTION

Referring to the figures, several views of the instant invention are presented. The map of the instant invention comprises a 3-dimensional, resilient form of material with “memory” that is painted, or otherwise marked, with information that may be helpful to users navigating regions such as, for example, ski areas. Other topographical areas may also be depicted. The map is preferably conveniently folded or rolled up and carried, and may be used multiple times.

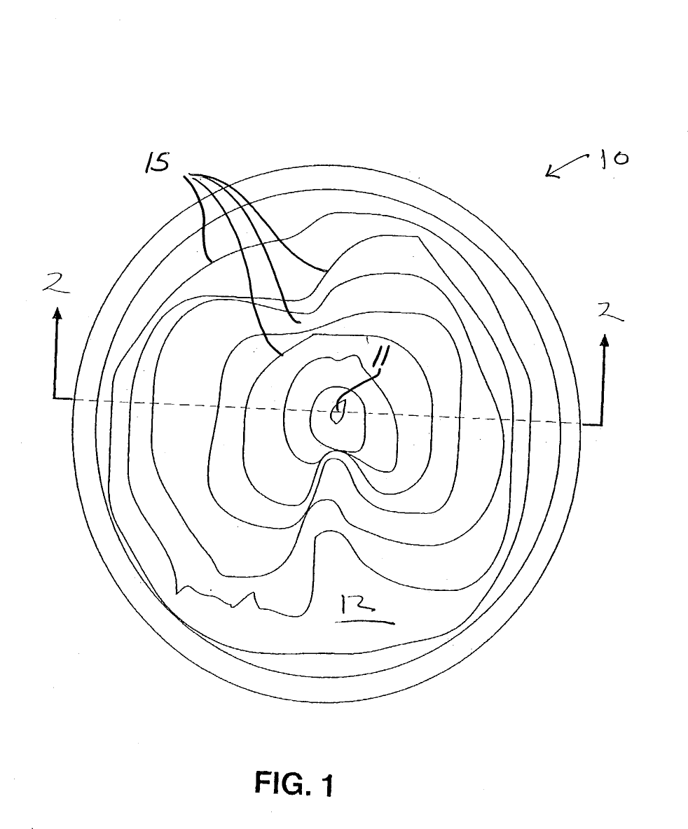

As shown in FIGS. 1-3, the map 10 of the instant invention readily expands to three dimensions when it is taken out of a storage state for use. The map has a top, outer surface 12 and a bottom, inner surface 14. The map may be constructed of latex rubber, or other suitable film or sheet material, the elastic properties of which allow it to repeatedly expand, when compacting forces are released, without additional effort by the user. In a film/sheet embodiment, the 3-dimensional form resulting from the thin film/sheet being shaped in the contour of the top surface of the mountain, valley, or other land is typically “hollow,” with a generally convex (viewed from above) top surface (12) and a generally concave(viewed from below) bottom, inner surface 14 surrounding and defining an interior space (13), and typically a bottom perimeter edge 19. The film/sheet may be thin to allow for optimal compaction, yet strong enough to maintain its form in an expanded state without additional support.

Alternatively, the 3-dimensional map form may also be made of foam rubber or other compressible material in a solid shape which also may be compressed and rolled. Such a solid embodiment would have a top surface shaped like the geography and contours of the area being portrayed, and may have a flat bottom surface rather than a concave bottom surface. Other embodiments of the invented map, for example, may be a “semi-solid” shape, with a continuous or partially continuous bottom surface but with hollow pockets inside the map body that make collapsing or compressing the map easier.

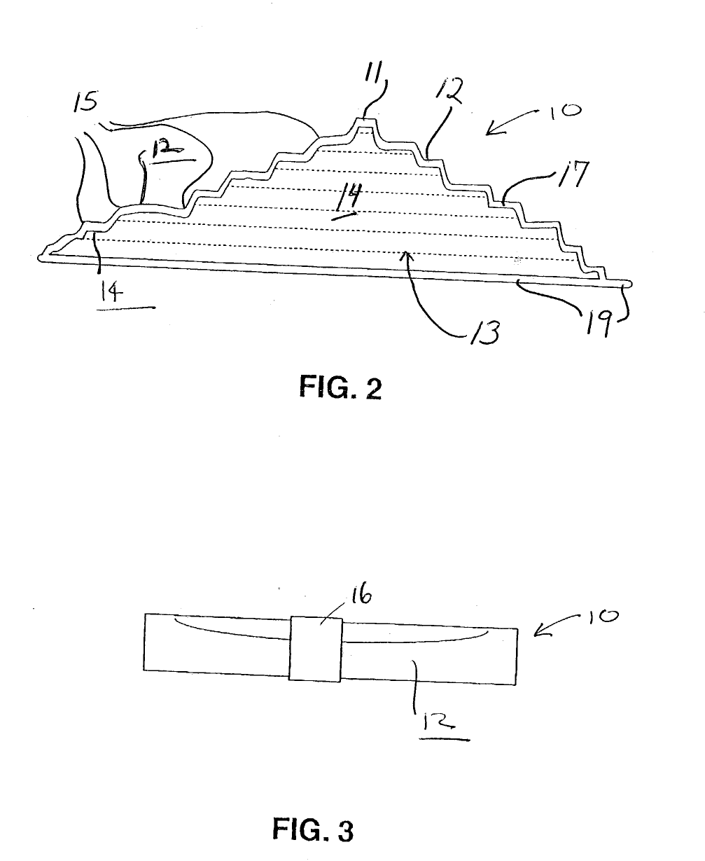

The 3-dimensional form is not necessarily created to scale, but is preferably designed to reveal the basic contours and details of the area such that users may recognize distinctive features or landmarks. For example, FIGS. 1 and 2 illustrate a map (10) of an area with a single, high peak (11) and many topographical features (15). FIGS. 1 and 2 illustrate an embodiment in which a thin film/sheet (17) forms the map top surface (12) and the interior surface (14).

Latex-type rubber or plastic material is preferred because it will not have fold lines in top surface 12 or a curved bottom perimeter platform (19) when unfolded or unrolled. Other, conventional rubber or plastic materials with these “memory” features may also be used. For purposes of this specification, memory refers to the capacity of suitable materials to return to their previous shape after having been deformed through folding or rolling.

As illustrated in FIG. 6, those responsible for producing the maps may paint or print the map 30 to reveal any information deemed helpful to the user. The paint used should be waterproof, or at least water-resistant, and durable enough to withstand repeated folding or rolling without cracking or peeling. The markings may include available ski runs 32, base lodges and the services they offer, ski lift locations 34, and/or other important structures or features that may be encountered in the area. Structures such as lodges may also be represented 3-dimensionally if desired. Different colors of paint may be used to simplify reading the map and improve the visual appeal. For example, for maps of ski areas, ski runs of similar difficulty may be shown in the same color as is practiced currently by most ski resorts.

Also, the indicia for the map may be formed within the map material when the map is manufactured. For example, the indicia may exist on a resilient pre-mold form which is then molded into a transparent material to create the 3-dimensional map.

As shown in FIG. 3, the map may be folded or rolled to allow for storage in between uses, or a foam map (not shown) may be compressed. The flexible material preferably allows the user to fold or roll the map to his or her personal satisfaction without affecting the map's further utility. When rolled, the map 10 may be secured in that state using, for example, a band 16. The compacted map may be stored in a ski-coat pocket, backpack, or other suitable compartment when not in use.

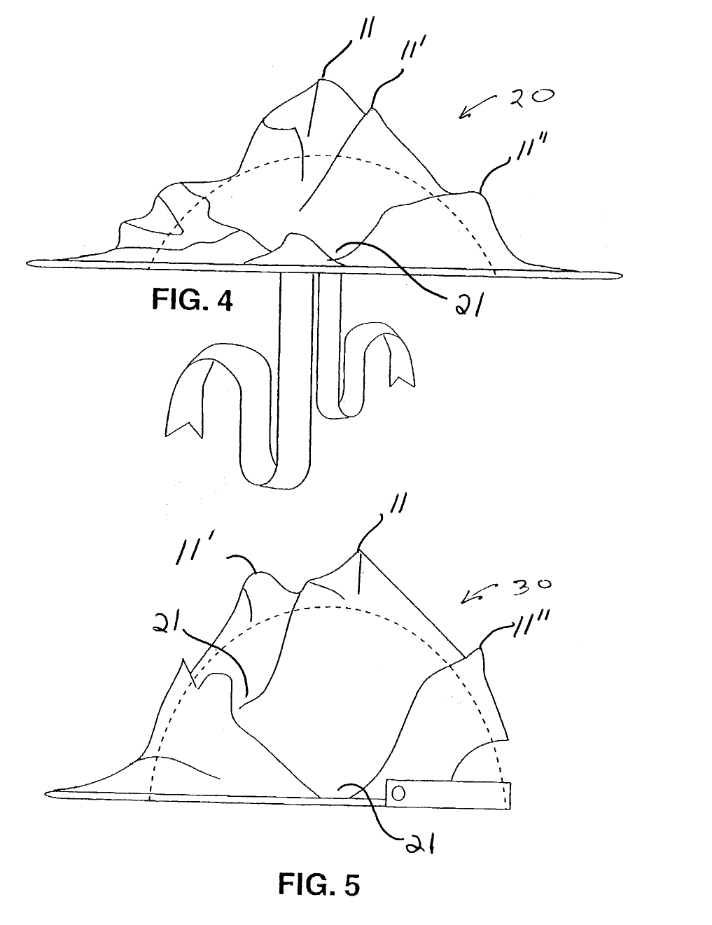

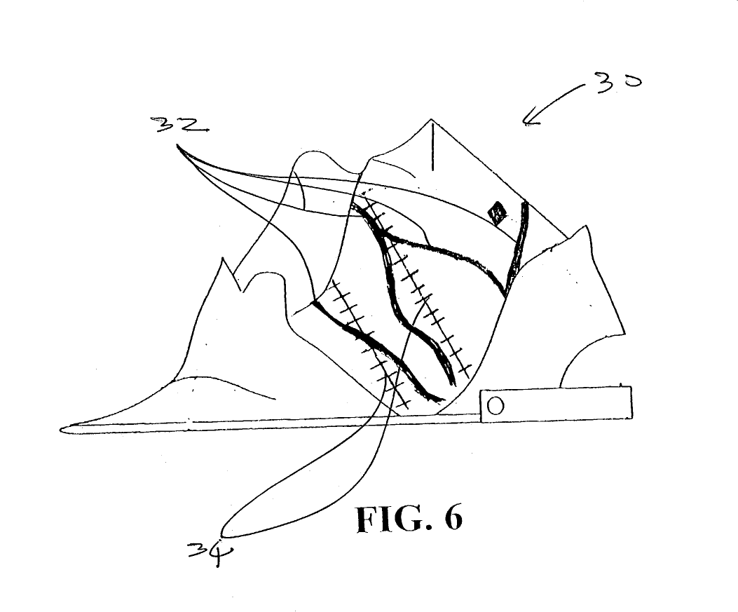

Referring to FIGS. 4 and 5, alternative embodiments, 20 and 30, respectively, of the instant invention are depicted in a sun hat design and a baseball cap design, respectively. In such hat designs, the map is attached/connected generally to the top of the hat, so as not to obstruct the space for receiving the head. The map of the present invention may be formed into the hat or it may be adapted to be placed on the hat permanently or semi-permanently. As shown in FIGS. 4 and 5, the top surface of the map may have multiple peaks (11, 11′, 11″), valleys (21), and multiple other “land-forms” that are very different from a conventional, smooth, smoothly-curved, or fabric hat crown.

FIG. 6 illustrates an embodiment 30 of the hat in FIG. 5, with added markings and indicia 32 and 34 on the outer surface of the map. The bold curved lines indicate location of ski runs on the particular mountain being portrayed, and straight, crosshatched lines indicate the locations of the chair lifts on the particular mountain. These may be done in black or colors, or with other symbols or other means. Colors and/or symbols may be used to match the ski resort's own colors or symbols that indicate difficultly of the ski run or other information. For example, the black diamond on FIG. 6 may indicate an “expert only” or “extremely difficult” ski run. Other markings may be added, such as names of runs, advertisements (i.e. brand names), resort names, or other landmarks, etc.

The instant invention may be made with conventional materials by conventional techniques. In the latex film case, the hollow form is probably best made by injection molding, with or without reinforcing fabric or plastic inserts. Or the latex film may be thermoformed in, for example, a two-part, press-type mold. In the solid foam rubber case, the 3-dimensional shape is probably best formed in an injection mold. Both hollow film/sheet embodiments and solid or semi-solid embodiments may be made of material that may be considered “flexible,” and, therefore, the term “flexible” in the claims includes film, sheet, rubber, foam, and other flexible materials.

Although this invention has been described above with reference to particular means, materials and embodiments, it is to be understood that the invention is not limited to these disclosed particulars, but extends instead to all equivalents within the scope of the following claims.

What is claimed is:

1. A 3-dimensional, flexible map having an outer surface, wherein said outer surface is adapted to display geographical information, said map being formed of a resilient material with memory so that the map may be easily, and repeatedly, folded or rolled for storage and unfolded or unrolled for use, said outer surface not having fold lines.

2. A map according to claim 1 wherein the map is formed of an expandable material, the elastic properties of which expandable material allow said map to be compacted and expanded repeatedly.

3. A map according to claim 1 wherein the map is an article of clothing when unfolded or unrolled.

4. The map according to claim 1 wherein the map is a hat or cap.

5. The map according to claim 1 wherein the map is adapted to be placed on a hat or cap.

6. The map according to claim 1, wherein said outer surface comprises one or more outwardly extending peaks adapted to represent mountain peaks.

7. The map according to claim 1, wherein said outer surface includes indicia comprising ski run markings.

8. The map according to claim 1, wherein said outer surface includes indicia comprising ski lift markings.

9. The map according to claim 1, wherein said outer surface includes indicia selected from the group consisting of: ski runs, ski lodges, ski lift locations, ski run difficulty markers.

10. The map according to claim 1, wherein said outer surface comprises one or more peaks adapted to represent mountain peaks, one or more depressions adapted to represent valleys, and indicia selected from the group consisting of: markings representing ski runs, markings representing ski lifts, markings representing paths, and markings representing trails.
